(19) United States
(12) Patent Application Publication
(10) Pub. No.: US 2006/0188204 A1
(43) Pub. Date: Aug. 24, 2006

(54) Method and apparatus for reducing feedback within an optical waveguide

(76) Inventor: Bernard G. Fidric, Cupertino, CA (US)

Correspondence Address: Brian F. Swienton;Spectra-Physics, 1335 Terra Bella Avenue, Mountain View, CA, 94043, US

(21) Appl. No.: 11/064,050

(22) Filed: Feb. 22, 2005

(51) Int. Cl. G02B 6/02; G02B 6/32; G02B 6/42; G02B 6/26

(52) U.S. Cl. 385/123; 385/33; 385/39; 385/31; 385/50

(57) ABSTRACT

An optical waveguide device is disclosed herein and includes a core having a first index of refraction and configured to propagate at least one optical signal therethrough, the core having a first end and a second end, wherein at least one of the first end and the second end forms a termination angle of about 15 degrees to about 75 degrees, and at least one outer material positioned about the core having a second index of refraction.

### BACKGROUND

Optical waveguides are presently used in a variety of applications. In recent years, fiber optic-based devices such as optical fiber lasers and fiber amplifiers have been receiving increasing attention. FIG. 1 shows one example of a fiber-optic device. As shown, the fiber optic device 1 comprises a core 3 surrounded by a cladding 5. Frequently, a protective layer 7 is applied to the cladding 5 to protect the cladding 5 and to prevent light from propagating therethrough. Further, the distal portion 9 of the fiber optic device 1 typically is cleaved to produce a termination surface 11. Presently, fiber optic devices 1 are typically cleaved such that the termination surface 11 is substantially perpendicular to the optical axis z of the fiber optic device 1. Optionally, the termination surface 11 may be polished or laser cut.

While these fiber optic devices and termination schemes have proven useful in the past, a number of shortcomings have been identified. For example, often feedback develops within the fiber-optic device 1. FIG. 2 shows fiber optic device 1 having an optical signal 13 propagating through core 3 and incident upon the termination surface 11. As shown, an output signal 15 is transmitted through the termination surface 11. Often, a portion of the signal 13 is reflected by the termination face 11. As shown in FIG. 2, the reflected signal 15′ may be internally reflected by the termination face 11 and may propagate through the core 3, cladding 5, and/or both. As such, the transmission efficiency of the fiber optic device 1 may be reduced. Further, the reflected signal 15′ may prove destructive to components, optical elements, and the like in optical communication with the fiber optic device 1. For example, the reflected signal 15′ may be transmitted to and incident upon one or more diode lasers in optical communication with the fiber optic device 1, thereby decreasing the operational efficiency or lifetime thereof.

In response to the foregoing, several manufacturers have produced fiber optics, connectors, or ferrules which include an angled termination surface 11. FIG. 3 shows an embodiment of a fiber optic device 1 having a termination surface 11 formed at a termination angle θ, relative to a plane N substantially perpendicular to the longitudinal axis z of the fiber optic device 1. Typical termination angles θ range from about 2 degrees to about 14 degrees, with typical standard angles at about 8 degrees. While these devices have proven to marginally reduce feedback into the core 3 of the fiber optic device 1, a number of shortcomings have been identified. For example, termination angles of about 2 degrees to about 14 degrees fail to substantially reduce feedback into the cladding 5 or structures surrounding the core 3 of the waveguide 1. FIG. 3 shows an optical signal 13 propagating through core 3 and incident upon the angled termination surface 11. As shown, an output signal 15 is transmitted through the termination surface 11. In addition, a portion of the optical signal may be reflected from the angled termination surface 11. The reflected light 15′ may be transmitted through the core 3, the cladding 5, or both. As such, the prior art devices having termination angles of about 2 degrees to about 14 degrees fail to reduce or prevent Fresnel reflections. Further, the transmission efficiency of the waveguide may be substantially reduced by reflections from the termination face 11.

Thus, in light of the foregoing, there is an ongoing need for a method and apparatus for reducing feedback within an optical waveguide.

### SUMMARY

Various embodiments of passive, or active guided wave devices and related integrated optical devices are disclosed herein. In one embodiment, an optical waveguide device is disclosed and includes a core having a first index of refraction and configured to propagate at least one optical signal therethrough, the core having a first end and a second end, the second end forming a termination angle of about 15 degrees to about 75 degrees, and at least one outer material positioned about the core having a second index of refraction.

In an alternate embodiment, the present application is directed to a fiber optic device and includes at least one optical conduit having a core portion of a first index of refraction configured to propagate an optical signal and a cladding of a second index of refraction, the optical conduit having a first end and a second end, the second end having a termination angle of about 15 degrees to about 75 degree formed thereon, a signal source positioned proximate to the first end of the optical conduit in optical communication with the core, and a pump source in optical communication with the cladding.

In still another embodiment, the present application discloses an optical waveguide device which includes a body configured to propagate at least one optical signal therethrough, the body having a first end and a second end, and an optical end cap coupled to at least one of the first end and the second end, the end cap having an termination surface of about 15 degrees to about 75 degrees.

In another embodiment, the present application is directed to an optical waveguide device, comprising a body configured to propagate at least one optical signal therethrough, the body having a first end and a second end wherein at least one of the first and the second end forms a termination angle of about 15 degrees to about 75 degrees.

Further, the present application discloses an optical waveguide device which comprises a core having a first index of refraction and configured to propagate at least one optical signal therethrough, the core having a first end and a second end, the second end forming a Brewster's angle, and at least one outer material positioned about the core having a second index of refraction.

In addition, the present application is directed to an optical waveguide device and includes a core having a first index of refraction and configured to propagate at least one optical signal therethrough, the core having a first end and a second end, wherein at least one of the first end and the second end forms an angle of about 15 degrees to about 75 degrees, and at least one outer material positioned about the core having a second index of refraction, wherein the first index of refraction is greater than the second index of refraction.

Other features and advantages of the embodiments of the waveguide devices as disclosed herein will become apparent from a consideration of the following detailed description.

### BRIEF DESCRIPTION OF THE DRAWINGS

Various devices for reducing the feedback within an optical waveguide will be explained in more detail by way of the accompanying drawings, wherein:

FIG. 1 shows an embodiment of a prior art optical waveguide having a termination surface formed substantially perpendicular to the longitudinal axis of the waveguide;

FIG. 2 shows the embodiment of the optical waveguide of FIG. 1 during use having an optical signal propagating therethrough;

FIG. 3 shows another embodiment of a prior art optical waveguide having a termination surface formed at an angle of about 8 degrees relative to a plane N which is substantially perpendicular to the longitudinal axis of the waveguide;

FIG. 4 shows an embodiment of an apparatus for reducing feedback within an optical waveguide having a termination surface formed at an angle of about 15 degrees to about 75 degrees relative to a plane N which is substantially perpendicular to the longitudinal axis of the waveguide;

FIG. 5 shows the embodiment of the optical waveguide of FIG. 4 during use having an optical signal propagating therethrough;

FIG. 6 shows another embodiment of an apparatus for reducing feedback within an optical waveguide having multiple termination surfaces formed at an angle of about 15 degrees to about 75 degrees relative to a plane N which is substantially perpendicular to the longitudinal axis of the waveguide;

FIG. 7 shows an embodiment of a waveguide end-cap apparatus for reducing feedback within an optical waveguide having a termination surface formed at an angle of about 15 degrees to about 75 degrees relative to a plane N which is substantially perpendicular to the longitudinal axis of the waveguide;

FIG. 8 shows another embodiment of a waveguide end-cap apparatus for reducing feedback within an optical waveguide having a termination surface formed at an angle of about 15 degrees to about 75 degrees relative to a plane N which is substantially perpendicular to the longitudinal axis of the waveguide;

FIG. 9 shows an embodiment of a waveguide end-cap apparatus for reducing feedback within an optical waveguide having a termination surface formed at an angle of about 15 degrees to about 75 degrees relative to a plane N which is substantially perpendicular to the longitudinal axis of the waveguide;

FIG. 10 shows another embodiment of a waveguide end-cap apparatus for reducing feedback within an optical waveguide having a termination surface formed at an angle of about 15 degrees to about 75 degrees relative to a plane N which is substantially perpendicular to the longitudinal axis of the waveguide;

FIG. 11 shows the embodiment of the optical waveguide of FIG. 7 affixed to an optical waveguide;

FIG. 12 shows an embodiment of an optical waveguide cap positioned within or otherwise integral to an attachment device;

FIG. 13 shows an embodiment of an optical coupler having an optical element positioned between a first and second waveguide; and

FIG. 14 shows another embodiment of an apparatus for reducing feedback within an optical waveguide having a reflective surface and an angled termination surfaces formed at an angle of about 15 degrees to about 75 degrees relative to a plane N which is substantially perpendicular to the longitudinal axis of the waveguide.

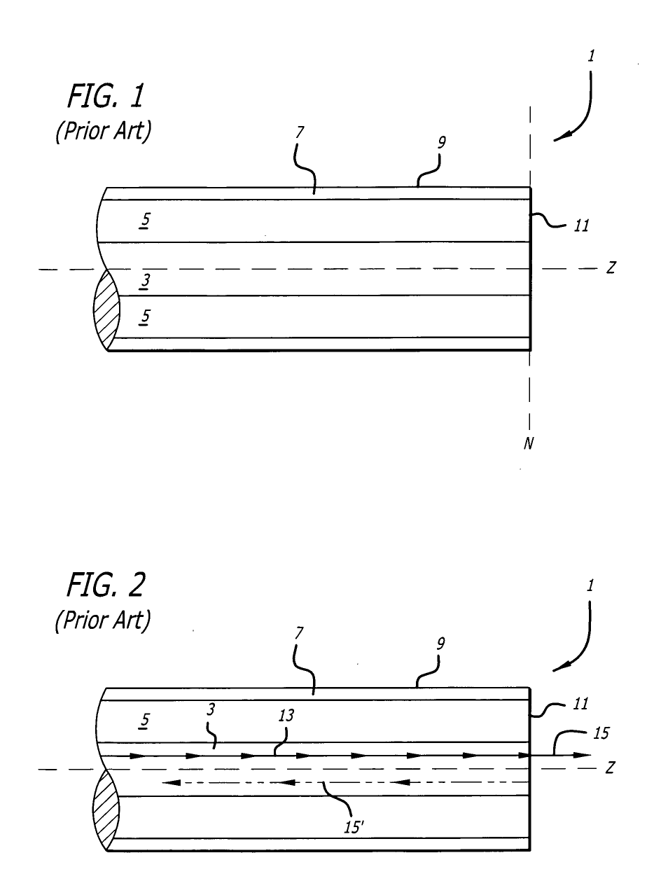

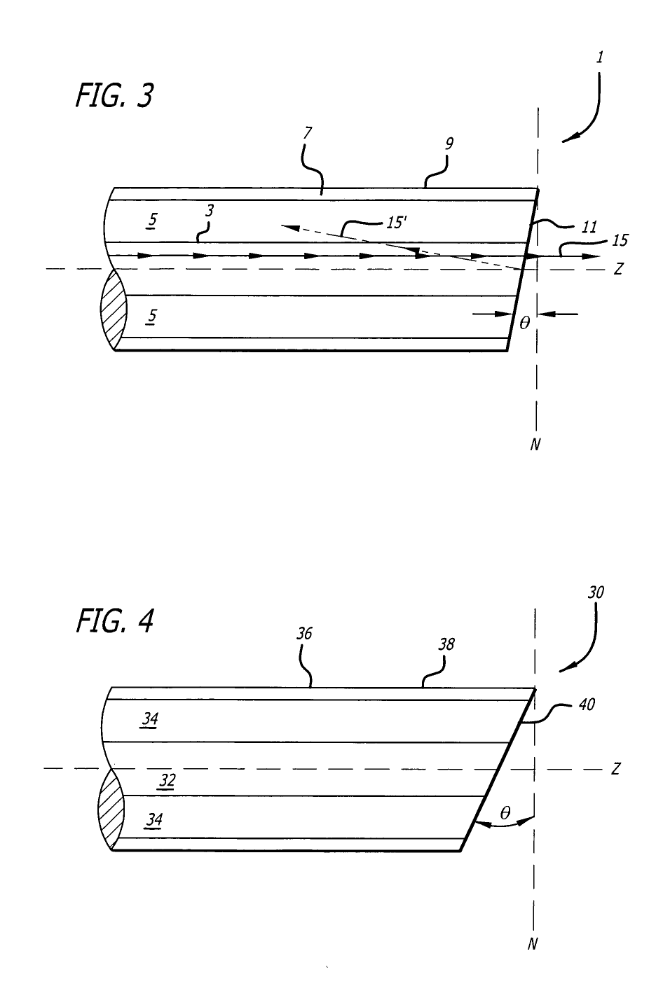

### DETAILED DESCRIPTION

FIG. 4 shows an embodiment of an apparatus for reducing feedback within an optical waveguide. As shown in FIG. 4, the waveguide 30 may comprise a fiber optic conduit having a core 32 of a first index of refraction positioned within at least one cladding 34 of a second index of refraction wherein the first index of refraction is greater than the second index of refraction. Exemplary fiber optic conduits include, without limitation, single mode optical fibers, large mode area optical fibers, polarization maintaining fibers, double clad fibers, photonic crystal fibers and the like. In an alternate embodiment, the waveguide 30 may comprise one or more optical crystal slabs or rods (including Nd:YAG materials), electro-optic devices including lithium niobate (LiNbO3) light modulators, semiconductor devices including semiconductor optical amplifiers, and the like. For example, the waveguide 30 may be formed from a Nd:YAG small diameter rod (e.g. from about 2 microns to about 50 microns) having a first index of refraction positioned within a fluid or solid environment having a second index of refraction. Exemplary fluid environments include, without limitation, air, water, and the like. Optionally, the core 32, the cladding 34, and/or both may contain one or more doping agents. Exemplary doping agents include, without limitation, erbium, neodymium, ytterbium, other rare earth elements, titanium-indifused and/or proton-exchange index-modifying agents, and the like. In one embodiment, the waveguide 30 or the components thereof may be manufactured from one or more polarization-maintaining or single polarization materials or configurations, thereby permitting the waveguide to maintain the polarization of at least one signal propagating therethrough. For example, the waveguide 30 may be configured to maintain the polarization of a vertically polarized or p-polarized signal propagating therethrough.

Referring again to FIG. 4, the waveguide 30, the core, 32, and/or the cladding 34 may be manufactured in any variety of diameters and/or lengths. For example, in one embodiment the core 32 may have a core diameter range from about 10 microns to about 50 microns. In another embodiment, the core diameter ranges from about 2 microns to about 10 microns. In one embodiment, the waveguide 30 is manufactured from a polarization maintaining (e.g., birefringent) material or design. In an alternate embodiment, the length of the waveguide 30 may be from about 2 millimeters to more than 100 meters. Further, the numerical aperture (NA) of the waveguide 30 may be from about 0.02 to about 1. For example, in one embodiment the NA of the waveguide 30 is about 0.10 to about 0.24.

As shown in FIG. 4, a protective coating or layer 36 may be applied to an outer surface of the cladding 34. In an alternate embodiment, the protective layer 36 may be applied to an outer surface of the core 32. Exemplary protective layers include, without limitation, various polymers, plastics, elastomers, vinyls, silicones, metals, composites, and the like. Further, multiple waveguides 30 may be grouped together, or embedded within each other, within a protective layer 36.

Referring again to FIG. 4, at least one end portion 38 of the waveguide 30 includes a termination surface or face 40. In one embodiment, the termination face 40 includes one or more coatings (not shown) applied thereto. For example, the one or more coatings includes a single or multi-layer dielectric anti-reflective coating. Optionally, the termination face 40 may manufactured without a coating applied thereto. As shown, the termination face 40 may be formed at a termination angle θ from about 15 degrees to about 75 degrees relative to a plane N substantially perpendicular to the longitudinal axis z of the fiber optic device 1. For example, in one embodiment the termination angle θ may be from about 30 degrees to about 38 degrees. In an alternate embodiment, the termination angle θ may substantially form Brewster's angle. As such, the termination angle 40 may be calculated using the formula:
θ=arctan(n₀/n₁)
wherein n₀ represents the index of refraction of the core 32 of the waveguide 30 and no represents the index of refraction of the medium into which (respectively, from which) the light is exiting (respectively, entering) the waveguide 30. Those skilled in the art will appreciate that no may be less than n₁. As such, the termination angle θ may be less than 45 degrees. For example, wherein n₀=1.45 to 1.46 (fused silica) and n₀=1 (air), then termination angle θ=34.5 degrees. Alternatively, no may be larger than n₁, and then θ is larger than 45 degrees. For instance, direct butt-coupling a single mode fiber (n₀=1.45) to another guided wave device such as a lithium niobate light modulator (n₀=2.15), or a semiconductor amplifier (InGaAsP: n₀=3.22) would be optimized for θ=56 degrees, or 66 degrees, respectively.

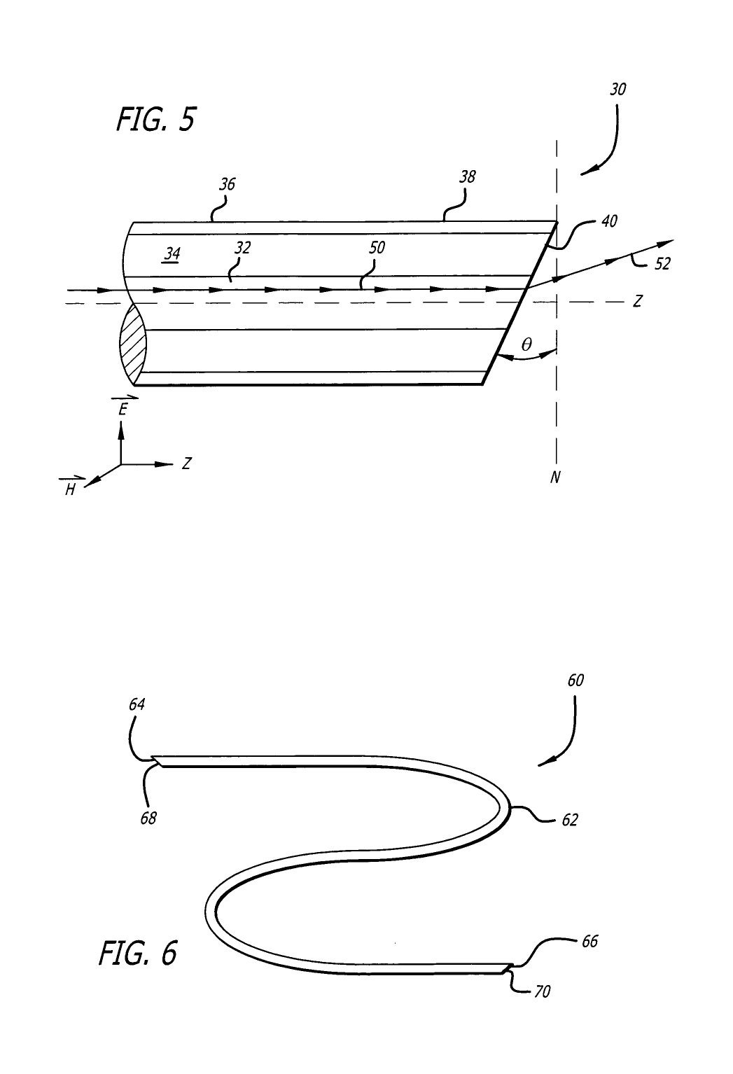

FIG. 5 shows an embodiment of the waveguide 30 having polarized light propagating therethrough. In one embodiment, the polarized light comprises linear or vertically polarized light in which the vibrations of the electric field (E) are rectilinear, parallel to a plane, and transverse to the direction of travel (propagation vector along axis z). When the plane of vibrations electric field (E) is parallel to the plane of incidence, the light wave is said to be vertically polarized or p-polarized. Conversely, when the plane of vibrations electric field (E) is perpendicular to the plane of incidence, the light wave is said to be horizontally polarized or s-polarized. As shown in FIG. 5, the vertically polarized light 50, having the electric field positioned along the y axis, may be configured to propagate through the core 32 of the waveguide 30. Thereafter, the polarized light 50 is incident upon the termination surface 40 formed at a termination angle θ from about 15 degrees to about 75 degrees relative to plane N which is substantially perpendicular to the longitudinal axis z of the waveguide 30, and emitted 52 from the waveguide 30. As shown in FIG. 5, a termination angle θ of about 15 degrees to about 75 degrees substantially reduces or eliminates back-reflected light from propagating through the core 32 and/or the cladding 34. As a result, the transmission efficiency of the waveguide 30 is higher than prior art systems.

FIGS. 4 and 5 show an embodiment of a waveguide 30 having an angled termination surface 40 configured to output light propagating therethrough. In an alternate embodiment, the waveguide 30 may include an angled termination surface 40 formed on a first end, a second end, or both. For example, FIG. 6 shows an embodiment of a waveguide device having angled termination surfaces formed on the first end and at least a second end thereof. As shown in FIG. 6, the waveguide 60 comprises a flexible body 62 positioned between a first end 64 and at least a second end 66. In an alternate embodiment, the body 62 may be rigid. Further, any number of ends may be formed on the body 62. For example, the body 62 may form a Y-body having a first end, a second end, and a third end. As shown in FIG. 6, the first end 64 includes an angled termination surface 68 similar to the angled termination surface 40 described above. Similarly, the second end 66 may also include an angled termination surface 70 similar to the angled termination surface 40 described above. In one embodiment, the first and second angled termination surfaces 68 and 70 are formed at equivalent angles. For example, in one embodiment the first and second angled termination surfaces 68, 70 are formed at an equivalent Brewster's angle. In an alternate embodiment, the first and second angled termination surfaces 68 and 70 may be formed at different angles. For example, the first angled termination surface 68 may be formed at 33.5 degree while the second angled termination surface 70 is formed at 35.5 degrees.

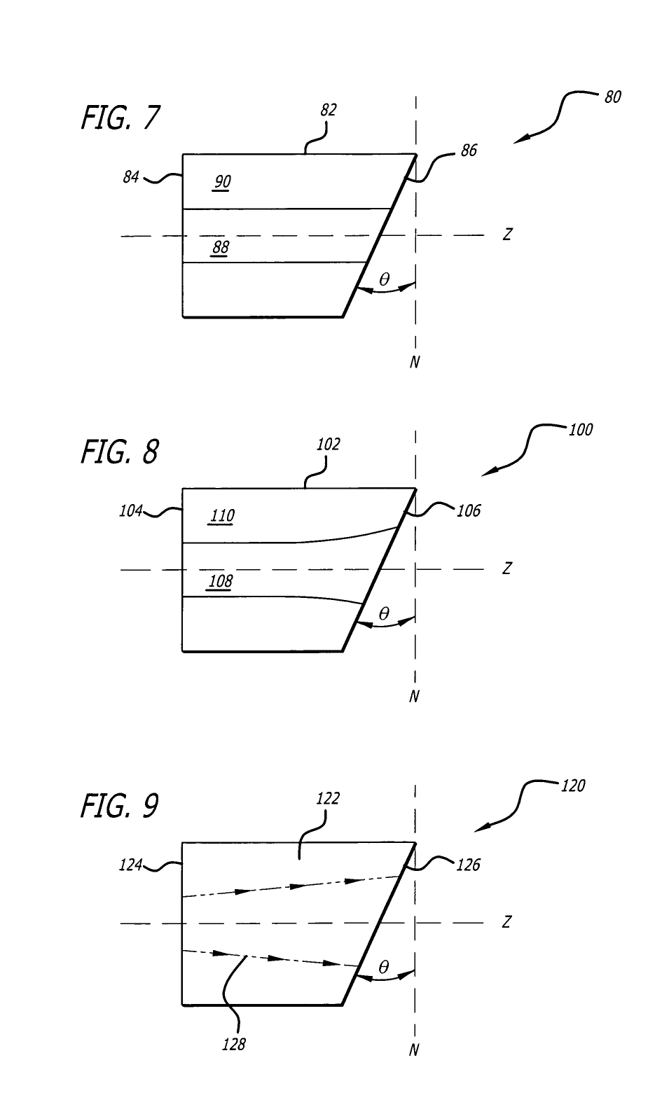

FIGS. 7-10 show an alternate embodiment of an apparatus for reducing feedback within an optical waveguide. FIG. 7 shows a waveguide end-cap 80 having a cap body 82. The cap body 82 includes a coupling surface 84 and an angled termination surface 86. The coupling surface 84 may be configured to couple to an optical waveguide. For example, in one embodiment the coupling surface 84 is formed substantially perpendicular to the longitudinal axis z of the cap body 82. Those skilled in the art will appreciate that the cap body 82 may be coupled to an optical waveguide in any variety of ways, including, without limitation, adhesively joined, bonded, fused, mechanically attached, and the like. Further, the cap body 82 may be formed in or otherwise disposed within a coupler, ferrule or connector device. Like the previous embodiments, the angled termination surface 86 may be formed at a termination angle θ from about 15 degrees to about 75 degrees relative to plane N which is substantially perpendicular to the longitudinal axis z of the waveguide 30. For example, the termination angle θ may form a Brewster's angle. Further, the cap body 82 may include a core 88 having a first index of refraction and a cladding 90 having a second index of refraction wherein the first index is greater than the second index.

FIG. 8 shows an alternate embodiment of a waveguide end-cap. As shown, the waveguide end-cap 100 may include a cap body 102 positioned between a coupling surface 104 an angled termination surface 106. The coupling surface 104 may be configured to couple to an optical waveguide. In the present embodiment, the cap body 102 includes a core 108 having a first index of refraction and a cladding 110 having a second index of refraction wherein the first index is greater than the second index. As shown in FIG. 8, the diameter of the core 108 may be variable within the cap body 102.

FIG. 9 shows an alternate embodiment of a waveguide end-cap. As shown, the waveguide end-cap 120 may include a cap body 122 positioned between a coupling surface 124 an angled termination surface 126. The coupling surface 124 may be configured to couple to an optical waveguide. In the present embodiment, the cap body 122 comprises a uniform refractive index body, i.e., coreless body, thereby eliminating the core and cladding of the previous embodiments. Like the previous embodiments, the angled termination surfaces shown in FIGS. 7-10 may be formed at a termination angle θ from about 15 degrees to about 75 degrees relative to plane N which is substantially perpendicular to the longitudinal axis z of the waveguide. For example, the termination angle θ may form a Brewster's angle. As shown in FIG. 9, polarized light 128 entering into the waveguide end-cap 120 may be permitted to diverge or expand from the optical axis z.

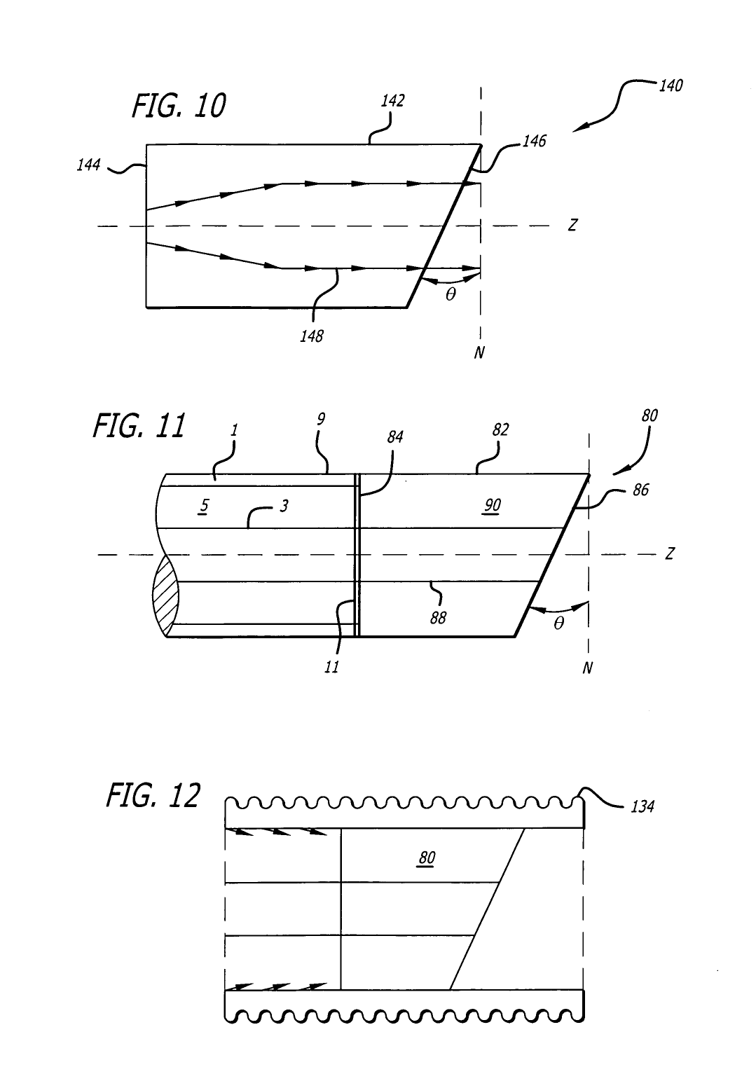

FIG. 10 shows an alternate embodiment of a waveguide end-cap. As shown, the waveguide end-cap 140 may include a cap body 142 positioned between a coupling surface 144 an angled termination surface 146. The coupling surface 144 may be configured to couple to an optical waveguide. In the present embodiment, the cap body 142 comprises a gradient index (GRIN) lens material, thereby collimating (respectively, focusing) the light beam coupled from (respectively, to) the optical waveguide. Like the previous embodiments, the angled termination surface 146 shown in FIG. 10 may be formed at a termination angle θ from about 15 degrees to about 75 degrees relative to plane N which is substantially perpendicular to the longitudinal axis z of the waveguide. For example, the termination angle θ may form a Brewster's angle. As shown in FIG. 10, polarized light 148 entering into the waveguide end-cap 140 may be permitted to first expand from the optical axis z, and then may be substantially collimated as it reaches the termination surface 146.

FIG. 11 shows an embodiment of a waveguide end-cap coupled to an optical waveguide. In the illustrated embodiment, the waveguide 1 includes a core 3 and a cladding 5. Further, the distal portion 9 of the waveguide 1 forms a termination surface 11 which is substantially perpendicular to the longitudinal axis z of the waveguide 1. Referring again to FIG. 11, the waveguide end-cap 80 is coupled to the distal portion 9 of the waveguide 1. The waveguide end-cap 80 includes a cap body 82 forming a core 88 and a cladding 90. As shown, the core 88 of the cap body 82 is in optical communication with the core 3 of the waveguide 1. Similarly, the cladding 90 of the cap body 82 is in optical communication with the cladding 5 of the waveguide 1. The cap body 82 further includes a coupling face 84 which is configured to engage and be coupled to the termination surface 11 of the waveguide 1. In addition, the cap body 82 includes an angled termination surface 86 formed at a termination angle θ from about 15 degrees to about 75 degrees relative to plane N which is substantially perpendicular to the longitudinal axis z of the waveguide 1. In the illustrated embodiment, the waveguide end-cap 80 is configured to receive light form the waveguide 1 and transmit light therefrom. For example, the waveguide end-cap 80 may be configured to propagate linear polarized light therethrough. In an alternate embodiment, the waveguide end-cap 80 may be coupling a waveguide 1 to a light source, thereby transmitting light from the light source to the waveguide 1.

FIG. 12 shows an embodiment of a waveguide end-cap included within an attachment device. As shown, the waveguide end-cap 80 is disposed within a attachment device body 134. The attachment device 134 permits the waveguide end-cap 80 to be easily coupled to an optical waveguide. Exemplary attachment devices include, without limitation, ferrules, connectors, and the like.

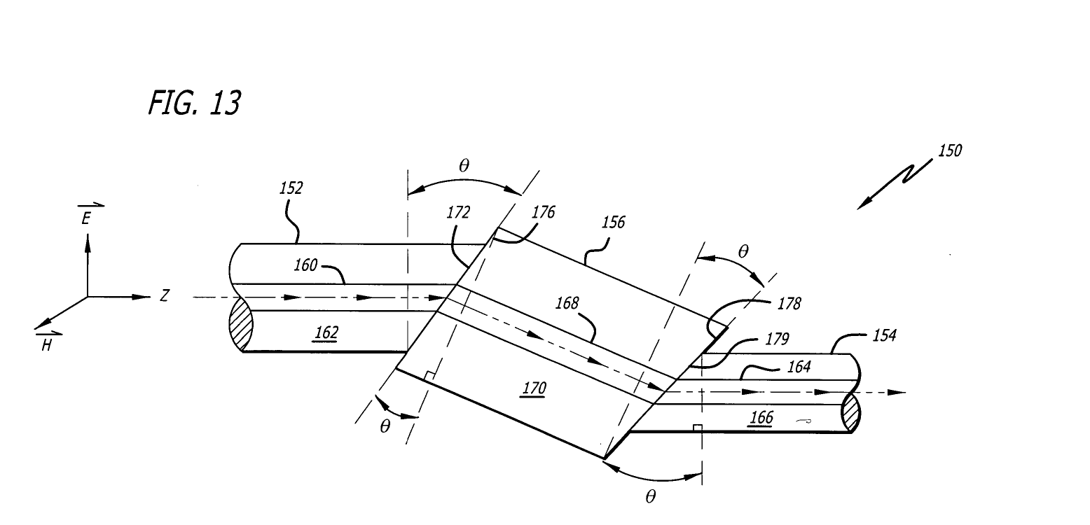

FIG. 13 shows another embodiment of an apparatus for reducing feedback within an optical waveguide. As shown, an active or passive optical device 150 is disclosed. The optical device 150 includes a first waveguide 152 in optical communication with a second waveguide 154 through at least one optical element 156. The core 160 of the first waveguide 152 is in communication with the core 164 of the second waveguide 154 through an optical pathway 168 formed in the optical element 156. Similarly, the cladding 162 of the first waveguide 152 is in communication with the cladding 166 of the second waveguide 154 through at least a second pathway 170 formed in the optical element 156. As shown, the first waveguide 152 includes a termination surface 172 formed at a termination angle θ from about 15 degrees to about 75 degrees relative to plane N which is substantially perpendicular to the longitudinal axis z of the waveguide. In addition, the second waveguide 154 includes a similar angled termination surface 174. Exemplary optical components 156 include, without limitation, optical crystals, non-linear optical materials, light modulators, semiconductor optical devices, electro-optic modulators, variable optical attenuators, optical amplifiers, optical repeaters, and the like. In the illustrated embodiment, the optical element 156 includes faces 176 and 178 formed at angles θ′ substantially complimentary to the angled termination surfaces 172, 174 of the first and second waveguides 152, 154, respectively (i.e., θ plus θ′ is about 90 degrees). In the illustrated embodiment, the index of refraction of first waveguide 152, and the second waveguide 154 are equivalent, and both are lower than the index of refraction of the optical element 156. In an alternate embodiment, the indices are varied.

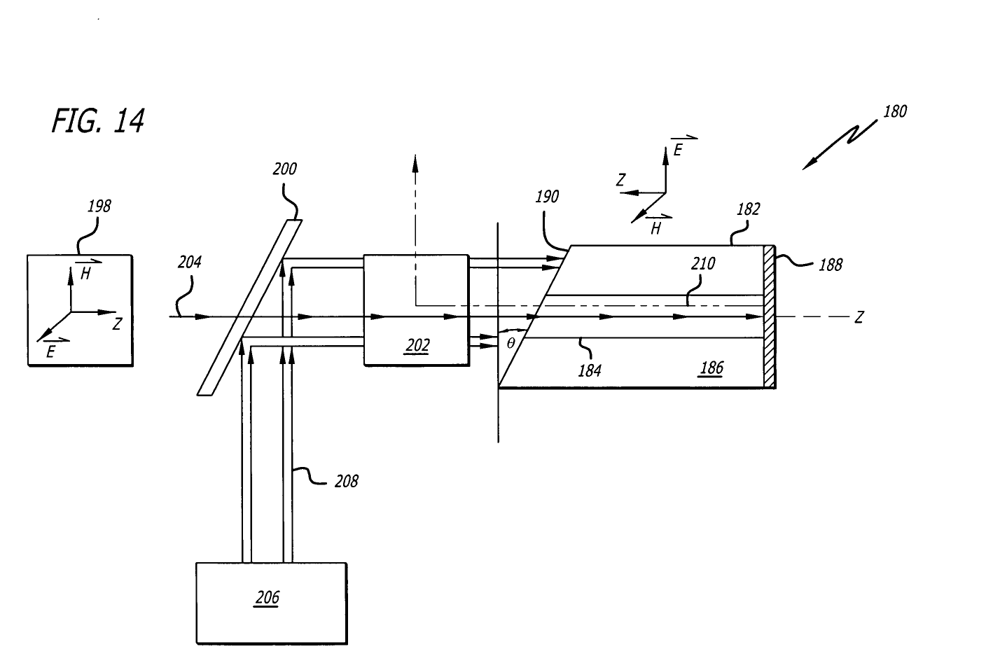

FIG. 14 shows an alternate embodiment of an apparatus for reducing feedback within an optical waveguide. As shown, the waveguide 180 includes a body 182 having a core 184 and at least one cladding 186. Further the body 182 includes a reflective surface 188 formed or otherwise disposed thereon. For example, the reflective element 188 may comprise a Faraday rotator mirror. The reflectivity of the reflective surface may be from about 80% to about 99.99%. In one embodiment, the reflective surface 188 comprises a mirror coupled to the body 1582. In an alternate embodiment, the reflective surface 188 may be integrally formed on the body 182. Like the previous embodiments, the body 182 includes an angled termination surface 190 formed at a termination angle θ from about 15 degrees to about 75 degrees relative to plane N which is substantially perpendicular to the longitudinal axis z of the waveguide 180. For example, the termination angle θ may form a Brewster's angle.

Referring again to FIG. 14, during use, one or more optical elements may be positioned between and in optical communication with a light source 198 and the waveguide 180. In the illustrated embodiment, a dichroic mirror 200 and a polarization beam splitter 202 may be used. As shown in FIG. 14, the light source 198 emits horizontally polarized (or s-polarized) signal light 204 which is directed into the waveguide 180. In addition, a pump source 206 provides pump radiation 208 to the waveguide 180. Optionally, the waveguide 180 may comprise a semiconductor optical amplifier. As such, the pump energy 208 provided thereto may comprise one or more electrical signals configured to drive the semiconductor device 182.

The pump radiation 208 may be directed to the waveguide 180 by the dichroic mirror 200. The horizontally polarized signal light 204 propagates through the core 184 of the waveguide 180 and is reflected by the reflective surface 188. As a result, the polarization is rotated. Thereafter, the p-polarized light propagates through the core 184 of the waveguide 180, and is emitted from the angled termination surface 190 formed thereon. The p-polarized light may be incident upon the polarization beam splitter 202 and extracted from the system. In one embodiment, the waveguide 180 is doped to form an optical amplifier. Exemplary doping agents include, without limitation, erbium, neodymium, ytterbium, other rare earth elements, titanium-indifused or proton-exchange index-modifying agents, and the like.

Embodiments disclosed herein are illustrative of the principles of the invention. Other modifications may be employed which are within the scope of the invention. Accordingly, the devices disclosed in the present application are not limited to that precisely as shown and described herein.

1. An optical waveguide device, comprising:
a core having a first index of refraction and configured to propagate at least one optical signal therethrough, the core having a first end and a second end, the second end forming a termination angle of about 15 degrees to about 75 degrees; and
at least one outer material positioned about the core having a second index of refraction.

2. The device of claim 1 wherein the optical signal is vertically polarized.

3. The device of claim 1 wherein the waveguide device comprises at least one fiber optic conduit.

4. The device of claim 3 wherein the at least one fiber optic conduit is selected from the group consisting of a single mode fiber optic device, a multimode fiber optic device, a large mode fiber optic device, a single clad fiber optic device, and a multiple clad fiber optic device.

5. The device of claim 1 wherein the waveguide comprises at least one polarization maintaining fiber optic conduit.

6. The device of claim 1 wherein the waveguide comprises an optical crystal.

7. The device of claim 6 wherein the optical crystal is selected from the group of electro-optic materials consisting of lithium niobate, potassium dihydrogen phosphate (KDP), potassium dideuterium phosphate (KD*P), lithium tantalite, and cadmium telluride.

8. The device of claim 1 wherein the waveguide is manufactured from a semi conductor material selected from the group consisting of silicon, germanium, GaAs, GaAsP, InGaAs, and InGaAsP.

9. The device of claim 1 wherein the first end forms an input angle of about 15 degrees to about 75 degrees.

10. The device of claim 1 wherein the core has a numerical aperture of about 0.02 to about 1.

11. The device of claim 1 wherein the termination angle is about a Brewster's angle.

12. The device of claim 1 wherein the termination surface further includes at least one coating applied thereto.

13. The device of claim 12 wherein the coating comprises an anti-reflection coating.

14. A fiber optic device, comprising:
at least one optical conduit having a core portion of a first index of refraction configured to propagate an optical signal and a cladding of a second index of refraction, the optical conduit having a first end and a second end, the second end having a termination angle of about 15 degrees to about 75 degree formed thereon;
a signal source positioned proximate to the first end of the optical conduit in optical communication with the core; and
a pump source in optical communication with the cladding.

15. The device of claim 14 wherein the optical signal comprises a vertically polarized signal.

16. The device of claim 14 wherein the termination angle is about Brewster's angle.

17. An optical waveguide device, comprising:
a body configured to propagate at least one optical signal therethrough, the body having a first end and a second end; and
an optical end cap coupled to at least one of the first end and the second end, the end cap having an termination surface of about 15 degrees to about 75 degrees.

18. An optical waveguide device, comprising a body configured to propagate at least one optical signal therethrough, the body having a first end and a second end wherein at least one of the first and the second end forms a termination angle of about 15 degrees to about 75 degrees.

19. An optical waveguide device, comprising:
a core having a first index of refraction and configured to propagate at least one optical signal therethrough, the core having a first end and a second end, the second end forming a Brewster's angle; and
at least one outer material positioned about the core having a second index of refraction.

20. An optical waveguide device, comprising:
a core having a first index of refraction and configured to propagate at least one optical signal therethrough, the core having a first end and a second end, wherein at least one of the first end and the second end forms an angle of about 15 degrees to about 75 degrees; and
at least one outer material positioned about the core having a second index of refraction, wherein the first index of refraction is greater than the second index of refraction.
